(19) United States
(12) Patent Application Publication
(10) Pub. No.: US 2005/0267780 A1
(43) Pub. Date: Dec. 1, 2005

(54) Methods and systems of automating medical device data management

(76) Inventors: Pinaki Ray, Fremont, CA (US); Greg Matian, Foster City, CA (US); Michael Bell, Morgan Hill, CA (US)

Correspondence Address: BOZICEVIC, FIELD & FRANCIS LLP, 1900 UNIVERSITY AVENUE, SUITE 200, EAST PALO ALTO, CA, 94303, US

(21) Appl. No.: 11/142,903

(22) Filed: May 31, 2005

Related U.S. Application Data
(60) Provisional application No. 60/576,359, filed on Jun. 1, 2004.

(51) Int. Cl. G06F 17/60

(52) U.S. Cl. 705/2

(57) ABSTRACT

Methods and systems automating medical device data management are provided. The subject methods and systems are implemented by or include a software program loadable on a host system. The software program is configured for polling medical devices located within a detectable range of the host system; detecting a medical device; downloading data from the detected medical device to the host system; and generating one or more reports comprising at least some of the downloaded data; wherein the aforementioned steps are performed without user intervention.

### CROSS-REFERENCE TO RELATED APPLICATIONS

This application claims the benefit of U.S. Provisional Patent Application Ser. No. 60/576,359, filed on Jun. 1, 2004, the disclosure of which is incorporated herein by reference in its entirety.

### FIELD OF THE INVENTION

This invention relates to methods and systems for use by healthcare professionals to manage a patient's health. More particularly, this invention pertains to decision support/data management software hosted on a computer or computer network to download data from medical devices, such as blood glucose meters.

### BACKGROUND OF THE INVENTION

Diagnostic medical devices that test patient body fluids to provide a snapshot of a particular disease state hold a lot of valuable data. The value of this data can be harnessed most effectively by software that downloads the data and presents intelligent analytical reports that can be used by healthcare professionals to make quick and informed therapy decisions.

Data management software is not widely used by healthcare professional (HCP) offices due to the time needed and the skill level of the staff needed to install and run software on a PC. The value of the reports generated by the software is appreciated by most healthcare professionals but the time spent and cost involved in getting familiar with new software created by multiple vendors, invoking it, navigating thru screens downloading device data and then generating and printing reports is prohibitive. Most data management software requires users to do additional data mining (date range, name of patient, report type, etc.) before a report is presented to them. Some vendors have created dedicated hardware solutions (for example, hardware that prints reports when connected to a blood glucose meter). This has its own drawbacks from the standpoint of taking up precious space in an HCP office, requiring additional ink and paper for printing, lack of the ability to customize reports, lack of the ability to change download behavior (i.e., add a patient name, require name authentication), lack of the ability to store data for historical trending, additional expenditure on a dedicated hardware etc. Also, the staff will need to be trained to operate the hardware. In some cases, these dedicated printers are provided in the front office for use by patients. This often creates issues with the Health Insurance Portability and Accountability Act of 1996 (HIPAA) since private health data is visible to other patients.

In addition, most desktop software and dedicated printers do not provide any audiovisual alerts related to patient compliance when downloading data from meters.

### SUMMARY OF THE INVENTION

The present invention provides methods and systems for managing medical device data, and is particularly suitable for use to improve work flow efficiency and allow multi-tasking in the healthcare professional's office. The methods and systems include software run on a host device, such as a PC, which is able to transmit and receive communications to and form medical devices, such as a blood glucose meter. Data stored in the device's memory is downloaded to the host device and analyzed according to customizable rules established by the healthcare professional. Optionally, reports of the organized data may be printed out automatically. The reports may be configured to display data generated over any period of time, for example, in order for the healthcare professional to observe new trends against historical data. The software may also allow the healthcare professional to do one or more of the following simultaneously: view another patient's data, enter data manually, create or modify analysis rules and/or set-up (i.e., customize, calibrate, etc.) a second meter while data is being downloaded from a first meter. Alerts such as audio and visual cues are provided to the healthcare professional to guide them thru the meter detection and report printing process. Furthermore, alerts (such as via audio cues, e-mails, etc.) are provided to the healthcare professional during data download if the patient's data indicates a need for immediate attention, based upon predefined rules or parameters dictated by the healthcare professional.

In one embodiment of the present invention, the software loads automatically on PC start-up. In this embodiment, the user, e.g., a healthcare professional or the patient, is only required to connect a meter to a cable whereby the reports are printed immediately from a local or network printer. Advantageously, there is no need for the user to learn how to navigate within the software program in order to download data, and to generate print reports based on the downloaded data. This “plug and print” mode of operation may also be employed by a receptionist or office assistant at an HCP office when a patient checks in for an appointment.

Another advantage of the present invention is that no dedicated hardware is required for printing. Office staff or other users may leverage existing local or onsite PCs and printers. At the same time, any number of customizable reports can be printed. Additionally, the software enables alerts specific to patient disease type to be displayed on the reports or computer monitor or to be audibly generated through the computer's speakers.

### BRIEF DESCRIPTION OF THE DRAWINGS

The invention will be further understood with reference to the attached drawing figures, in which:

FIG. 1 is a schematic illustration of a networked system with which the software of the present invention may be employed;

FIG. 2 is a schematic illustration of an exemplary application of the subject software employed in a healthcare professional's office in which wireless communication is used;

FIG. 3 is a schematic illustration of the software according to the present invention;

FIG. 4 is a schematic illustration of an Internet-based or local area network (LAN)-based system or environment with which the software of the present invention may be employed;

FIGS. 5A and 5B provide a flow chart of the process steps according to the methods of the present invention; and

FIG. 6 illustrates an exemplary graph illustrating glycemic event or trend information which can be provided by implementation of the methods and systems of the present invention.

### DETAILED DESCRIPTION OF THE PREFERRED EMBODIMENTS

Before the present invention is described, it is to be understood that this invention is not limited to the particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the preferred methods and materials are now described.

It must be noted that as used herein and in the appended claims, the singular forms “a”, “an”, and “the” include plural referents unless the context clearly dictates otherwise. Thus, for example, reference to “data” includes a plurality of types of data and reference to “the medical device” includes reference to one or more medical devices and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided might be different from the actual publication dates which may need to be independently confirmed.

While the presently contemplated best mode of practicing the invention and preferred embodiments thereof are primarily described in the context of glucose monitoring and glucose monitoring devices, such description is not to be taken in a limiting sense, but is provided merely for the purpose of describing the general principles of the invention. Other applications of the present invention include, for example, cardiac rhythm monitoring or management, epileptic event monitoring, blood pressure monitoring or management, insulin pump management, physical activity monitoring, etc.

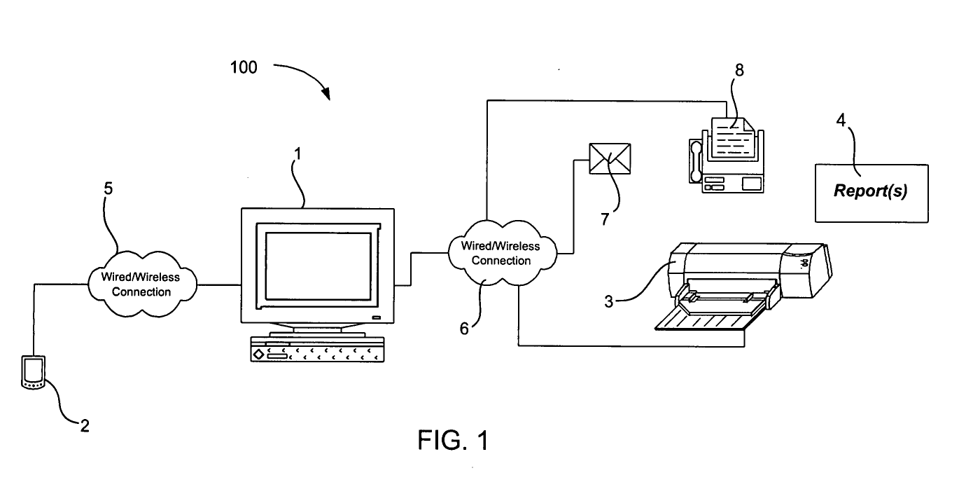

FIG. 1 is a schematic illustration of a networked system 100 with which the software of the present invention may be employed. The subject software is hosted on a device 1, such as a PC or PDA. Device 1 is in hardwire or wireless communication with one or medical devices 2, such as a blood glucose monitor, and one or more information output means, such as a printer 3, email system 7 and facsimile machine 8. Medical device 2 is automatically detected by the host device 1 upon which data, e.g., patient-specific glucose event and trend information, medication compliance, etc., is automatically transferred from the diagnostic device 2 to the host device 1 using a connectivity media 5 where the data is stored in a database or other memory for application, analysis and later acquisition. During the data transfer and storage in the database, visual and audio alerts are provided to the healthcare professional indicating patient compliance to established therapy rules, specific to disease type and patient medical history. Host device 1 then compiles, analyzes and organizes the data according to user-selected parameters. The information is then formatted into one or more reports 4 which are then sent automatically to one or more data output means via connection means 6. The data output means includes but is not limited to a printer 3, a fax machine 8 and an electronic file which may be transmitted through email or the like.

Reports 4 can be generated in the form of text, graphs, matrix charts, pie charts, etc. Standard information that may be provided on a report includes but is not limited to patient name and account number, meter serial numbers, HCP office visitation log, etc. Also, the software may be configured to provide trend graphs that display causes of glycemic events, e.g., food, medication, exercise, stress, etc, in a unique iconic format. Additional color-coded alerts can be provided on the printed report 4 to assist the healthcare professional to assess data outside normal parameters and limits

The connection means 5 and 6 may take the form of a direct serial or USB cable connection; a TCP/IP or Ethernet based network connection; or a wireless connection using protocols like 802.11, infrared (IR) or radiofrequency (RF), e.g., Bluetooth. Detection of the diagnostic medical device 2 by host device 1 done automatically whereby medical device 2 identifies itself to host device 1 via an interrupt mechanism that notifies the host 1 that a device 2 wants to communicate with it. Alternatively, the host device 1 could continuously poll for any device 2 and initiate communication with it upon detection. Host device 2 may be configured, i.e., programmed accordingly, to automatically download data from device 2 and to print reports 4 upon establishing communication between the two devices by a hard connection, such as a cable or wired network, or by a wireless connection, such as by IR or RF signals, where the user has transmitted a signal prompting host device 1 of the desire to transfer records.

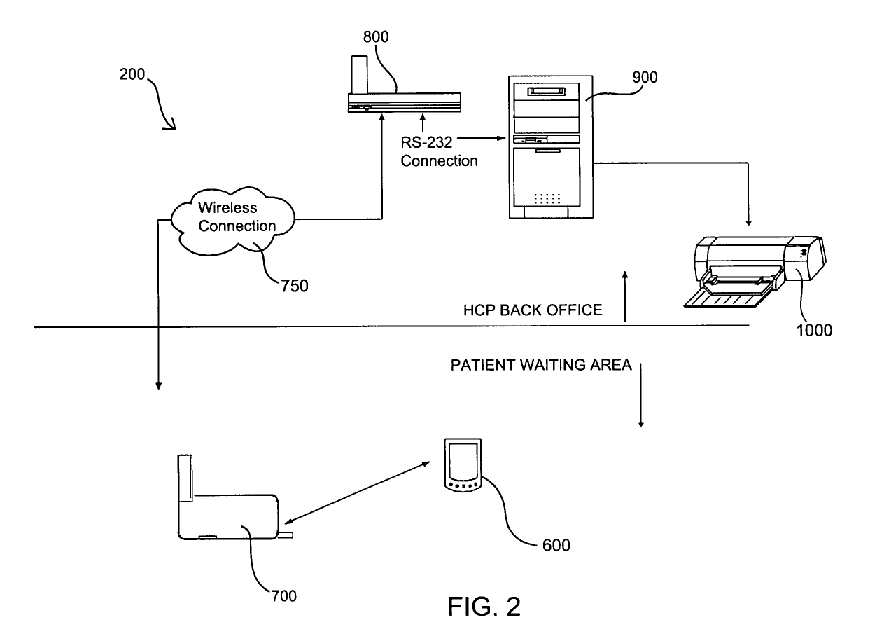

FIG. 2 is a schematic illustration of an exemplary application 200 of the subject software program employed in an HCP office having a back office and a patient waiting area. A host device 900, such as PC or handheld device, e.g., PDA, cell phone, etc., loaded with the subject software service and program and a printer 1000, by which reports can be printed automatically for use by the healthcare personnel, are placed in the back office where patients would not have access to HIPAA regulated data. Wireless communication 750 is established between a medical device 600 brought in by a patient visiting the clinic and host system 900 by way of transceivers 700 and 800, the former of which is stationed in the patient waiting area and the latter of which is stationed in the back office. Transceiver 800 may be a stand alone component connected to the communication port of the host 900 by way of a standard interface cable through an RS-232 compatible serial port, or may be integrated within host 900. Transceiver 700 may also be a standalone unit provided with a similar cable which is connectable to medical device 600, or may be integrated into medical 600.

In one embodiment, host 900 periodically transmits a “FIND METER” command on to wireless transceiver 700 via transceiver 800. Wireless transceiver 700 in turn relays the FIND METER command to device 600. In response, device 600 transmits a device serial number back to host device 900 which recognizes the device serial number and associates it with a pre-existing patient code or establishes a new account for the patient. Alternatively, upon detection of a new meter/patient, the program can be configured to prompt the HCP office user to enter pertinent user data to add the new patient to the system. Host device 900 in turn transmits a signal back to device 600 requesting data transfer. The transferred data is then stored in host device 900 in association with the existing patient or newly established patient account (or keep it in temporary memory in another embodiment). A report module of the subject software runs the reports according to a standing order or an otherwise real-time request and sends them to printer 1000 automatically.

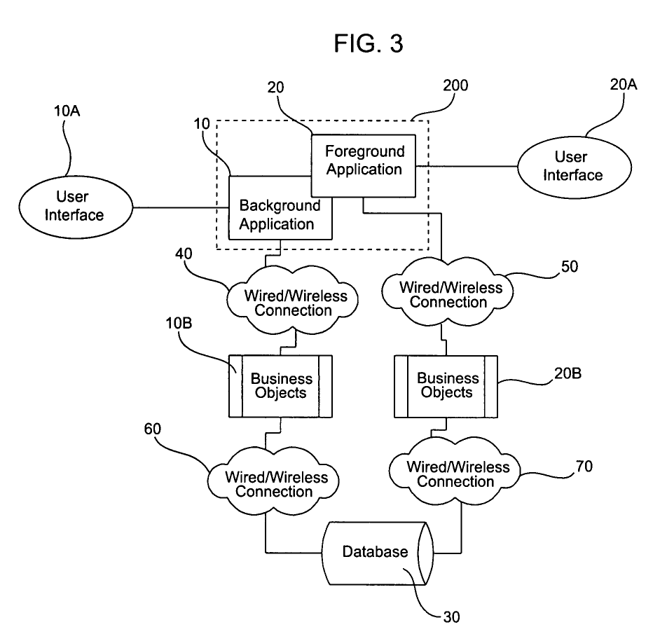

FIG. 3 is a schematic illustration of the various application and/or data components or aspects of the present invention. A software program 200 includes a background or service application 10 and a foreground application 20. Background application runs continuously upon start up of a user's system. By way of user interface 10A, a healthcare professional can configure or customize the parameters of the background service 10 based on the rules established within the healthcare practice. Such rules may include but are not limited to the types of reports, the format the reports (e.g., print color) and the data included in the reports, etc. Subsequent to initial configuration of background application 10, further user interface is not necessary unless the rules need to be modified. Background application 10 accesses business objects 10B and other data stored in database 30 via connection means 40 and 60, respectively. Foreground application 20 is only activated by user input. It has its own user interface 20A, by which a user may actively submit data or query for data output, and its own business objects 20B. Foreground application 20 accesses business objects 20B and other data stored in database 30 via connection means 50 and 70, respectively. While the two applications may each have their own database, sharing database resources has the advantages of allowing the background application to access historical data (i.e., previously downloaded data) as well as real-time data (i.e., last download), and to access rules of the foreground application. The business objects 10A and 20A process patient-specific data against established rules which define goals/targets, alert thresholds, etc. which are stored in database 30. In particular, the business objects dictate the type and extent of data or information provide on a report produced by the system.

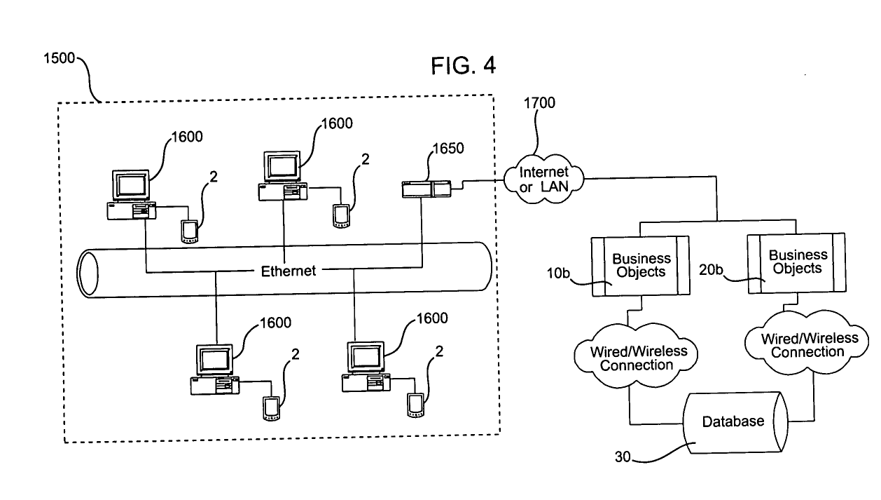

FIG. 4 is a schematic illustration of a system network or environment with which the software and/or data components of FIG. 3 may be employed. In such an environment, network 1500 may involve a network of multiple clients 1600 and/or individually serviced clients interconnected through the Ethernet and then routed through a router 1650. The client host device or system may be a PC or handheld devices, such as a PDA, which hosts background service 10 and foreground application 20 described above. A diagnostic device 2 and a printer 1000, as described above, may be connected to each of the client host systems 1600. The user interface for these clients may be browser based or Windows based. The network 1500 and individual clients 1600 communicate with the services of the present invention via an Internet-based or local area network (LAN)-based.

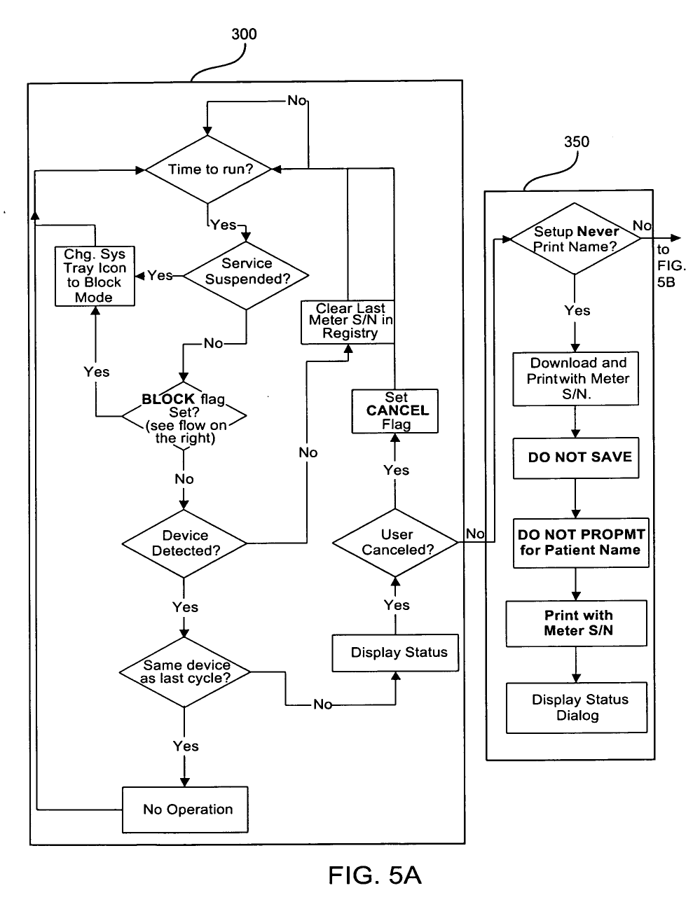

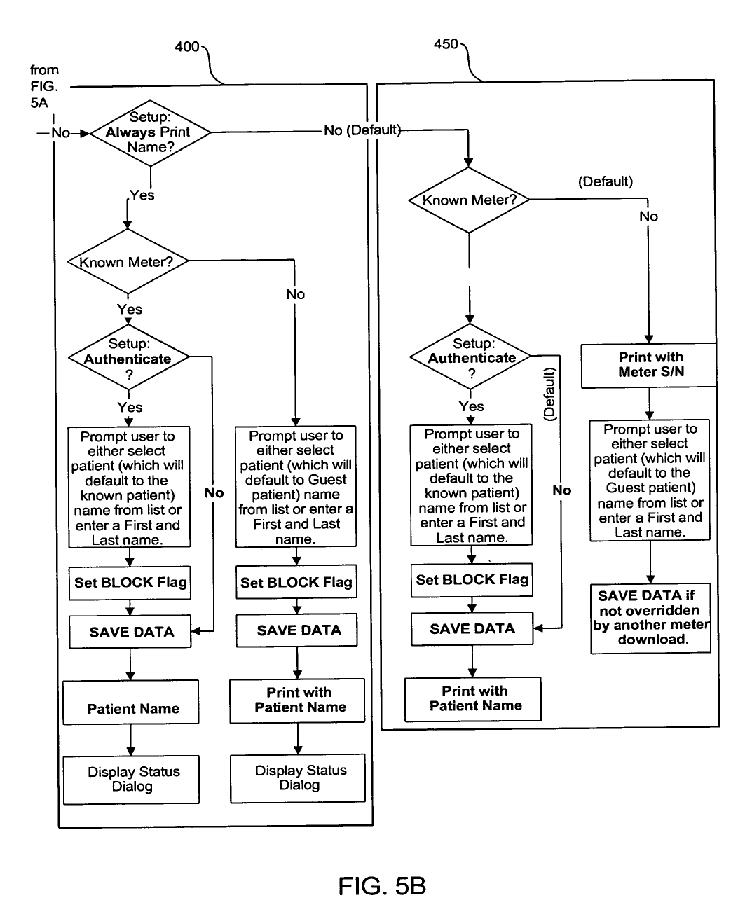

FIG. 5 illustrates a flow chart of the operation of the system of the present invention. The main flow path 300 of the invention illustrates the basic handshaking that takes place between the background and foreground applications, discussed above with respect to FIG. 3. The background application of the system operates in cycles referred to as scan cycles, whereby the service periodically wakes up from a sleep or wait mode and conducts a number of checks and executes certain instructions, after which the background service returns to a sleep or wait mode for a fixed period of time. When the background application is awake or active, the system scans for and is able to detect the presence of a designated medical device. If it is not suspended (due to activity in the foreground application), the service will check if it has been blocked by a pending action from the user (e.g. an open dialog box prompting the user to enter a patient name). If a designated device is detected, the background service determines whether the detected device is the same device that was last detected. If the same device is detected, the operation is ceased thereby preventing repetitive printing of the same report. However, if a different device is detected, the user is alerted to the fact by audio-visual cues, and the relevant data is automatically downloaded to the user's system from the device and printed, emailed or faxed according to a preconfigured report processing and printing scheme.

Before providing a detailed description of the report processing and printing configurations, the handshaking between the background and foreground applications is described with reference to main flow path 300. As the background and foreground applications share common functionality and resources when communicating with a medical device, only one application can be active at a time. As such, a mechanism is required whereby each of the two applications can notify the other when the required resources are in use by it.

If a user attempts to perform any meter communication function from the foreground application when the background application is actively communicating with a meter, a message is sent to the user interface of the foreground application indicating that the background service is busy and that the user should try again later. Visa-versa, when the foreground application is actively communicating with a meter, the background application becomes suspended. Examples of actions or processes initiated by a user with the foreground application which will suspend the background application include but are not limited to displaying meter communication instruction pages; and activating the meter download, setup or clear screen (at least until the user exits the screen). Upon completion of the operation or transmission, the suspension is cleared. Meanwhile, the background service continuously checks the status of the flag when it is available to scan for a device.

Referring again to subroutines 350, 400 and 450, the system can be configured to store data and print reports in a customized manner. Typically, customization involves the amount of patient data that is to be printed on a report. For privacy and other administrative reasons, a HCP may wish to limit the amount of patient data that is provided in report and stored on its system. Subroutine 350 provides a report with minimal patient data and does not save any of the data in the user's system. In particular, the patient name is never used but instead, the service is configured to identify the patient according to the serial number of the detected medical device. On the other hand, the user may want the report to identify the patient by name, such as provided by each of subroutines 400 and 450. When the user (HCP) chooses to always have the patient name printed on reports, subroutine 400 executes. With subroutine 400, when the meter detected is unknown, the user is prompted to enter or select the patient name. This sets the BLOCK flag, putting the background service in a wait mode. The background service is not able to process/detect additional medical devices in this state. When a patient name is entered, the downloaded data, including the meter's serial number, is saved and associated with the patient name in a database and the BLOCK flag is removed. When the detected meter is “known” by the system (i.e., is one that corresponds to a previously existing patient account stored in the software database), prior to saving the data, the foreground application first authenticates or confirms whether the meter is still associated with previously identified patient or is now used by a different patient. This step ensures that every meter's data is associated with the correct patient in the database. When the user (HCP) chooses to have a report printed without any obstruction to the office workflow whatsoever, i.e., with minimum software prompts, subroutine 450 (preferably the default routine) is executed. That is, if the meter is known, a report is printed with the patient name associated with the meter, or if the meter is unknown to the software, a report is printed only with the meter's serial number. In the latter case, the user is then prompted to enter the patient name, and the background application is blocked. If this prompt goes unanswered, and another meter is detected at this time, the background application is unblocked.

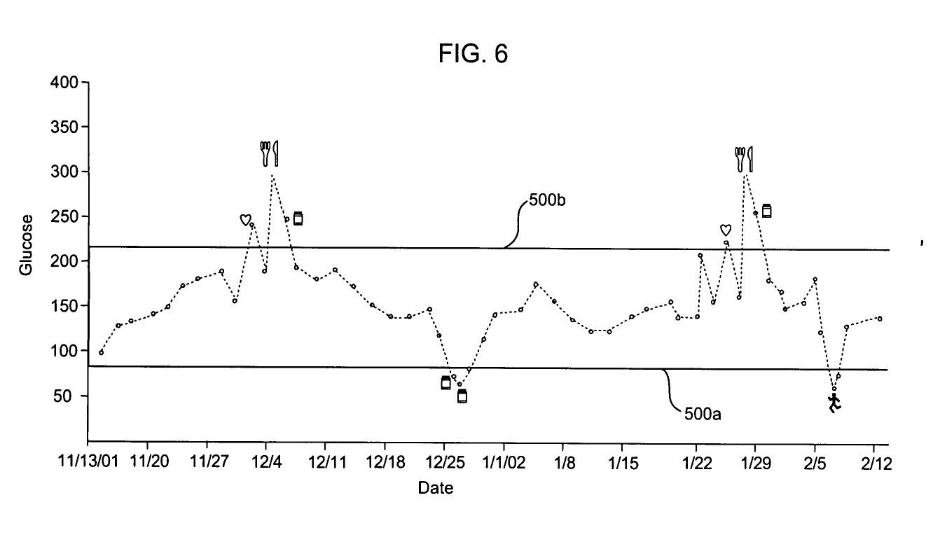

FIG. 6 illustrates an example of one type of report that may be generated by the subject invention. This report is a glucose trend graph wherein the data points signify the occurrence of a glycemic event. Acceptable glucose levels fall between minimum and maximum values 500a, 500b. Data points or glycemic events falling below minimum value 500a and above maximum value 500b are tagged with various icons symbolic of the glycemic event (e.g., a heart signifying a stressful event, a fork and knife signifying that the patient has eaten; a pill bottle signifying that the patient has taken medication or insulin, and a running figure signifying that the patient has exercised). The glycemic events can be automatically tagged by the meter or can be manually entered by the user. An HCP can consider the collective events and the corresponding glucose trend in order to more effectively make recommendations to the patient regarding, e.g., food intake, exercise and medication administration. The system can be further configured whereby additional details, e.g., the specific type of event, date and time of the event or glucose measurement, the value of measurement, user comments, etc., of about an event may be displayed when a mouse is hovered over the corresponding event icon.

Also provided by the subject invention are kits for use in practicing the subject methods. The kits include software programs recorded on a CD-ROM, DVD or USB plug or the like, which programs may be downloaded to the meter, PDA and/or an external data device for use with the systems. Finally, the kits may further include instructions for customizing, calibrating and/or configuring subject devices and systems. These instructions may be present on one or more of the packaging, label inserts or containers within the kits, or may be provided on a CD-ROM or the like.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

1. A method of automating medical device data management, the method comprising:
polling for medical devices located within a detectable range;
detecting a medical device;
downloading data from the detected medical device to a host system; and
generating one or more reports comprising at least some of the downloaded data;
wherein the aforementioned steps are performed without user intervention.

2. The method of claim 1 wherein the one or more reports are prepared according to parameters determined by a healthcare professional.

3. The method of claim 1 further comprising at least one of: printing the one or more reports, faxing the one or more reports or emailing the one or more reports automatically without user intervention.

4. The method of claim 1 further comprising uploading a software program to the host system, wherein the software program controls the performance of the aforementioned steps.

5. The method of claim 4 wherein the software program comprises a background application for polling and detecting the medical device.

6. The method of claim 5 further comprising prompting a user for data to be included in the one or more reports, wherein the software program further comprises a foreground application for prompting the user.

7. The method of claim 6 further comprising suspending the background application if the user does not provide the data.

8. The method of claim 1 wherein detecting the medical device comprises connecting the device to the host system.

9. The method of claim 1 further comprising storing the downloaded data in memory.

10. The method of claim 1 further comprising combining the downloaded data with existing data pertaining to the detected medical device according to parameters defined by a user.

11. The method of claim 10 wherein the user is a healthcare professional and the host system is located at a healthcare professional's office.

12. The method of claim 1 wherein the polling is continuous.

13. The method of claim 1 wherein the polling is periodic.

14. The method of claim 1 wherein the one or more reports comprise historical data stored in memory by the host system.

15. The method of claim 1 wherein the one or more reports comprise audio and visual alerts related to the downloaded data.

16. The method of claim 1 wherein the method is implemented through a networked environment.

17. The method of claim 16, wherein the networked environment is selected from the Internet or a land area network.

18. The method of claim 1, wherein the steps of polling, detecting and downloading are accomplished by wireless modes of communication.

19. The method of claim 1, wherein the host system comprises a PC.

20. The method of claim 1, wherein the detected medical device is a glucose measurement meter.

21. The method of claim 20, wherein the report comprises a glucose trend graph.

22. The method of claim 21, wherein the glucose trend graph comprises iconic event markers.

23. A system of automating medical device data management, the system comprising:
a host system; and
a software program loadable on the host system and configured for:
polling for medical devices located within a detectable range of the host system;
detecting a medical device;
downloading data from the detected medical device to the host system; and
generating one or more reports comprising at least some of the downloaded data;
wherein the aforementioned steps are performed without user intervention.

24. The system of claim 23 further comprising at least one of a printer, a fax machine and email system interfaced with the host system.

25. The system of claim 23 wherein the host system is located at a healthcare professional's office.

26. The system of claim 23 wherein the host system comprises a PC.

27. The system of claim 23 wherein the system is used in a networked environment.

28. The system of claim 27, wherein the networked environment is selected from the Internet or a land area network.

29. The system of claim 23, wherein the software program comprises a background application and a foreground application, wherein the background application is suspended when the foreground application is active and visa versa.

30. The system of claim 29 further comprising a database, wherein data stored in the database are accessible by the background application and by the foreground application.

31. A software program loadable on a host system, the software program comprising:
means for polling for medical devices located within a detectable range of the host system;
means for detecting a medical device;
means for downloading data from the detected medical device to the host system; and
means for generating one or more reports comprising at least some of the downloaded data;
wherein the aforementioned steps are performed without user intervention.

32. The software program of claim 31, wherein parameters for generating the one or more reports and/or storing data are customizable by a user.
